(19) United States
(12) Patent Application Publication
(10) Pub. No.: US 2017/0118401 A1
(43) Pub. Date: Apr. 27, 2017

(54) ELECTRONIC DEVICE AND METHOD FOR PROCESSING IMAGE

(71) Applicant: Samsung Electronics Co., Ltd., Gyeonggi-do (KR)

(72) Inventors: Hyunock YIM, Seoul (KR); Junmo Kim, Gyeonggi-do (KR); Sukyung Kim, Gyeonggi-do (KR); Kyungtae Kim, Daegu (KR); Hoewon Kim, Gyeonggi-do (KR); Jeongyong Park, Gyeonggi-do (KR); Eunsun Ahn, Gyeonggi-do (KR); Jaehee Jeon, Seoul (KR)

(73) Assignee: Samsung Electronics Co., Ltd.

(21) Appl. No.: 15/297,697

(22) Filed: Oct. 19, 2016

(30) Foreign Application Priority Data
Oct. 21, 2015 (KR) 10-2015-0146908

(51) Int. Cl. H04N 5/232; G06F 3/0484

(52) U.S. Cl. CPC H04N 5/23216; H04N 5/23293; G06F 3/04842

(57) ABSTRACT

An electronic device and a method for processing an image in the electronic device are provided. The method includes selecting a plurality of first images; identifying an option from a user; selecting a plurality of second images from the plurality of selected first images based on the identified option; and displaying the plurality of selected second images in a grid form.

### PRIORITY

This application claims priority under 35 U.S.C. §119(a) to Korean Patent Application Serial No. 10-2015-0146908, which was filed in the Korean Intellectual Property Office on Oct. 21, 2015, the entire disclosure of which is incorporated herein by reference.

### BACKGROUND

1. Field of the Disclosure

The present disclosure relates generally to an electronic device and a method for processing a photographic image.

2. Description of the Related Art

While high speed continuous photographing has been enabled in camera devices, a user may still be inconvenienced by having to check, one by one, each of a plurality of captured images captured by continuous photographing, in order to select an optimum image from the captured images.

### SUMMARY

Accordingly, an aspect of the present disclosure is to provide a device and a method for quickly and easily selecting an optimum image desired by a user.

Another aspect of the present disclosure is to provide a device and a method for analyzing a plurality of images and automatically selecting an image satisfying a specific condition desired by a user.

In accordance with an aspect of the present disclosure, an electronic device is provided, which includes a memory; and a processor configured to select a plurality of first images stored in the memory, identify an option for selecting an optimum image from the plurality of selected first images, select a plurality of second images from the plurality of selected first images based on the identified option, and display the plurality of selected second images in a grid form.

In accordance with another aspect of the present disclosure, a method is provided for processing an image in an electronic device. The method includes selecting a plurality of first images; identifying an option from a user; selecting a plurality of second images from the plurality of selected first images based on the identified option; and displaying the plurality of selected second images in a grid form.

In accordance with another aspect of the present disclosure, a recording medium is provided for operating in a device. The recording medium is configured to store instructions, which when executed by the device, instruct the device to perform a method that includes selecting a plurality of first images; identifying an option from a user; selecting a plurality of second images from the plurality of selected first images based on the identified option; and displaying the plurality of selected second images in a grid form.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to an embodiment of the present disclosure;

FIG. 2 illustrates an electronic device according to an embodiment of the present disclosure;

FIG. 3 illustrates a programming module according to an embodiment of the present disclosure;

FIG. 4 illustrates an electronic device according to an embodiment of the present disclosure;

FIG. 5 is a flowchart illustrating a method for processing an image in an electronic device according to an embodiment of the present disclosure;

FIG. 6 illustrates a plurality of images stored in a memory according to an embodiment of the present disclosure;

FIG. 7 illustrates a plurality of images selected as object choices according to an embodiment of the present disclosure;

FIG. 8 illustrates a grid setting screen according to an embodiment of the present disclosure;

FIG. 9 illustrates an image selection option screen according to an embodiment of the present disclosure;

FIG. 10 illustrates images selected and stored in separate folders according to an embodiment of the present disclosure;

FIG. 11 illustrates a screen for selecting and displaying images in a grid form according to an embodiment of the present disclosure; and

FIG. 12 illustrates a screen for editing a selected image according to an embodiment of the present disclosure.

### DETAILED DESCRIPTION

The following description, with reference to the accompanying drawings, is provided to assist in a comprehensive understanding of various embodiments of the present disclosure as defined by the claims and their equivalents. Although the description includes various specific details to assist in that understanding, these details are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used herein are not limited to their dictionary meanings, but are merely used to provide a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

Herein, singular forms, such as “a,” “an,” and “the,” include plural referents unless the context clearly dictates otherwise. Thus, for example, reference to “a component surface” includes reference to one or more of such surfaces.

Terms such as “include,” “may include,” “have,” etc., may be construed to denote a certain characteristic, function, number, operation, constituent element, component, or a combination thereof, but may not be construed to exclude the existence of or a possibility of addition of one or more other characteristics, functions, numbers, operations, constituent elements, components, or combinations thereof.

Further, the expression “and/or” includes any and all combinations of the associated listed words. For example, the expression “A and/or B” may include A, may include B, or may include both A and B.

Expressions including ordinal numbers, such as “first” and “second,” etc., may modify various elements. However, such elements are not limited by the above expressions. For example, the above expressions do not limit the sequence and/or importance of the elements, but are used merely for the purpose to distinguish an element from the other elements. Accordingly, a first user device and a second user device indicate different user devices although both of them are user devices. Further, a first element could be referred to as a second element, and similarly, a second element could be referred to as a first element, without departing from the scope of the present disclosure.

When a component is referred to as being “connected to” or “accessed by” another component, it should be understood that not only the component is directly connected or accessed by the other component, but another component may exist between them. However, when a component is referred to as being “directly connected to” or “directly accessed by” another component, there is no other component therebetween.

An electronic device according to an embodiment of the present disclosure, e.g., a device including a communication function, may be a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, a home appliance (e.g., an air-conditioner, vacuum, an oven, a microwave, a washing machine, an air cleaner, etc.), an artificial intelligence robot, a television (TV), a digital video disk (DVD) player, an audio device, a medical device (e.g., a magnetic resonance angiography (MRA) device, a magnetic resonance imaging (MRI) device, a computed tomography (CT) device, a scanning machine, a ultrasonic wave device, etc.), a navigation device, a global positioning system (GPS) receiver, an event data recorder (EDR), a flight data recorder (FDR), a set-top box, a TV box (e.g., Samsung HomeSync™, Apple TV®, or Google TV®), an electronic dictionary, a vehicle infotainment device, an electronic equipment for a ship (e.g., navigation equipment for a ship, a gyrocompass, etc.), avionics, a security device, electronic clothing, an electronic key, a camcorder, a game console, a head-mounted display (HMD), a flat panel display device, an electronic frame, an electronic album, furniture or a portion of a building/structure that includes a communication function, an electronic board, an electronic signature receiving device, a projector, etc.

An electronic device according to an embodiment of the present disclosure is not limited to the aforementioned devices.

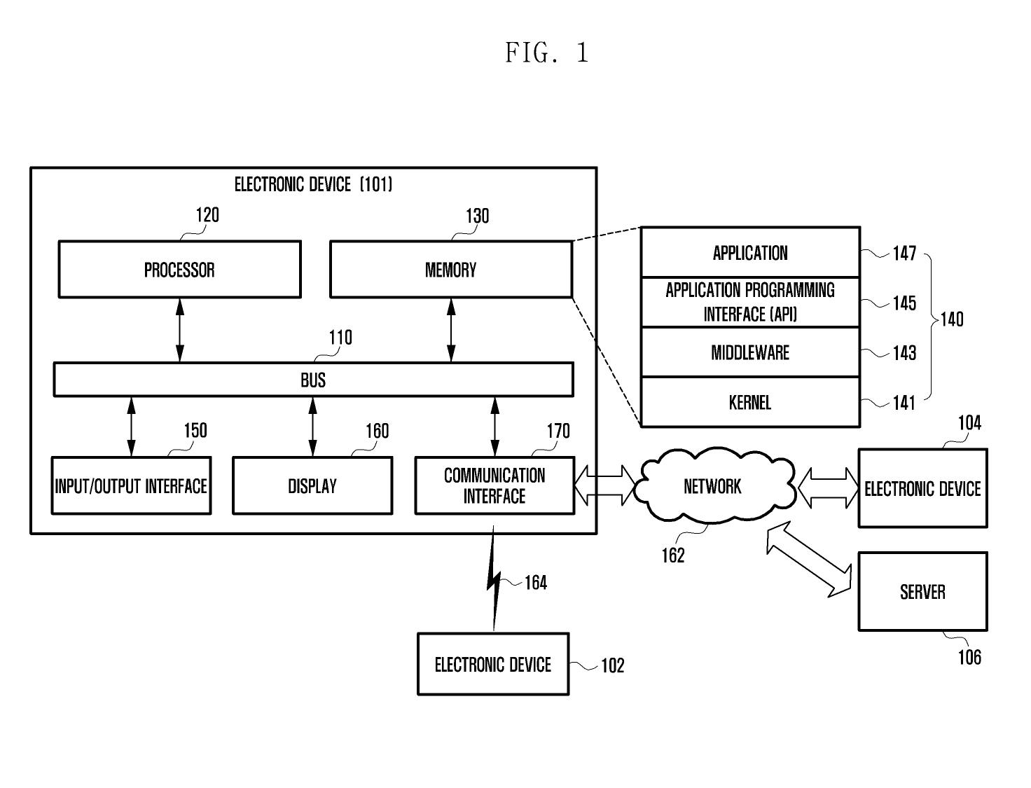

FIG. 1 illustrates an electronic device according to an embodiment of the present disclosure.

Referring to FIG. 1, the electronic device includes a bus 110, a processor 120, a memory 130, an input/output interface 150, a display 160, and a communication interface 170.

The bus 110 may be a circuit that interconnects the above-described elements and delivers communication (e.g., a control message) between the above-described elements.

The processor 120 may receive commands from the above-described other elements (e.g., the memory 130, the input/output interface 150, the display 160, the communication interface 170, etc.) through the bus 110, may interpret the received commands, and may execute calculation or data processing according to the interpreted commands.

The memory 130 may store commands or data received from or generated by the processor 120 or other elements. The memory 130 includes programming modules 140, such as a kernel 141, middleware 143, an application programming interface (API) 145, and an application 147. Each of the above-described programming modules 140 may be implemented in software, firmware, hardware, or a combination of two or more thereof.

The kernel 141 may control or manage system resources (e.g., the bus 110, the processor 120, the memory 130, etc.) used to execute operations or functions implemented by other programming modules (e.g., the middleware 143, the API 145, and the application 147). Also, the kernel 141 may provide an interface capable of accessing and controlling or managing the individual elements of the electronic device by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from the application 147 and/or the middleware 143, for example, may perform load balancing of the work requests by using a method of assigning a priority, in which system resources (e.g., the bus 110, the processor 120, the memory 130, etc.) of the electronic device can be used, to the application 147.

The API 145 is an interface through which the application 147 is capable of controlling a function provided by the kernel 141 or the middleware 143, and may include at least one interface or function for file control, window control, image processing, character control, etc.

The input/output interface 150 may receive a command or data as input from a user, and may deliver the received command or data to the processor 120 or the memory 130 through the bus 110. The display 160 may display a video, an image, data, etc., to the user.

The communication interface 170 may connect communication between another electronic device 102 and the electronic device 100. The communication interface 170 may support a short-range communication protocol 164 (e.g., Wi-Fi, BlueTooth (BT), and Near Field Communication (NFC)), or network communication 162 (e.g., the Internet, a local area network (LAN), a wide area network (WAN), a telecommunication network, a cellular network, a satellite network, a plain old telephone service (POTS), etc.).

Each of the electronic devices 102 and 104 may be identical to (e.g., of an identical type) or different from (e.g., of a different type) the electronic device 100.

Further, the communication interface 170 may connect communication between a server 164 and the electronic device 100 via the network communication 162.

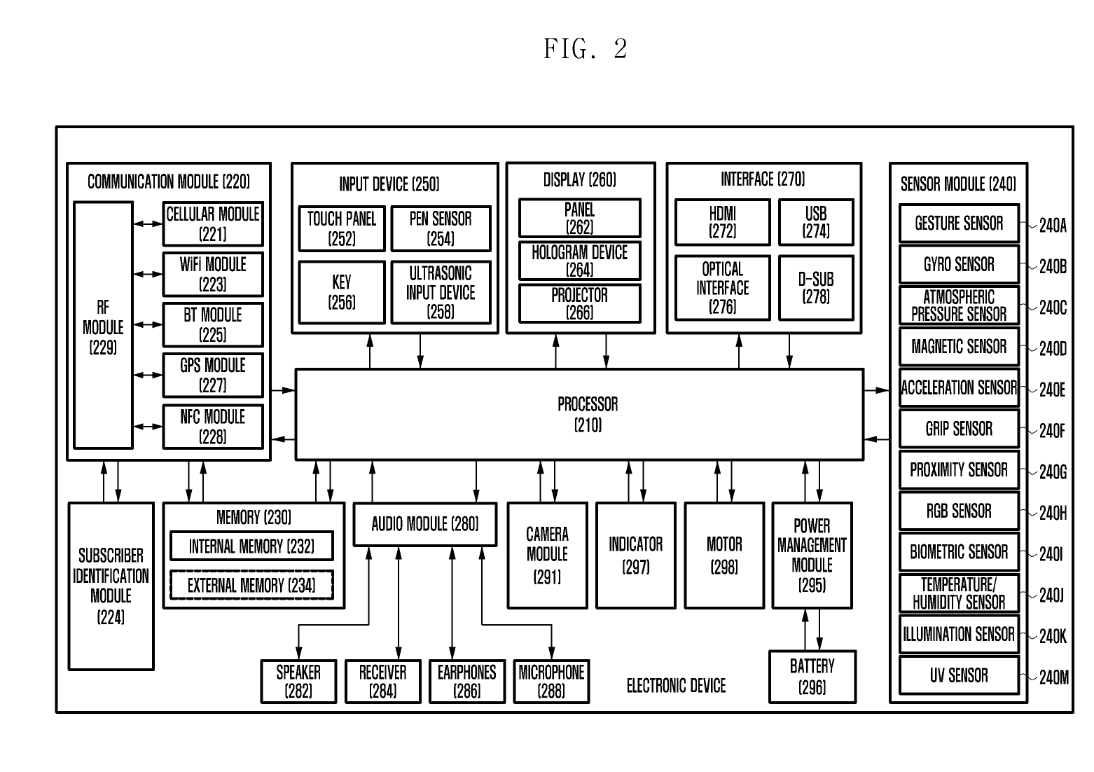

FIG. 2 illustrates an electronic device according to an embodiment of the present disclosure.

Referring to FIG. 2, the electronic device includes a processor 210, a communication module 220, a subscriber identification module (SIM) 224, a memory 230, a sensor module 240, a input device 250, a display module 260, an interface 270, an audio module 280, a camera module 291, a power management module 295, a battery 296, an indicator 297, and a motor 298.

The processor 210 may include one or more application processors (APs) and/or one or more communication processors (CPs).

The processor 210 may execute an operating system (OS) or an application program, and thereby may control multiple hardware or software elements connected to the processor 210 and may perform processing of and arithmetic operations on various data including multimedia data. The processor 210 may further include a graphical Processing Unit (GPU). For example, the processor 210 may be implemented by a system on chip (SoC).

The processor 210 may manage a data line and may convert a communication protocol for communication between the electronic device including the hardware and different electronic devices connected to the electronic device through the network. The processor 210 may perform at least some of multimedia control functions. The processor 210 may distinguish and authenticate a terminal in a communication network by using the SIM 224. The processor 210 may also provide the user with services, such as a voice telephony call, a video telephony call, a text message, packet data, etc.

Further, the processor 210 may control the transmission and reception of data by the communication module 220.

In FIG. 2, although elements such as the communication module 220, the power management module 295, the memory 230, etc., are illustrated as being separate from the processor 210, the processor 210 may include at least some of the above-described elements.

The processor 210 may load, to a volatile memory, a command or data received from at least one of a non-volatile memory and other elements connected to each of the processor 210, and may process the loaded command or data. The processor 210 may also store, in a non-volatile memory, data received from or generated by at least one of the other elements.

The SIM 224 may include a SIM card, which may be inserted into a slot formed in a particular portion of the electronic device. The SIM 224 may include unique identification information (e.g., integrated circuit card identifier (ICCID)) or subscriber information (e.g., international mobile subscriber identity (IMSI)).

The memory 230 includes an internal memory 232 and an external memory 234.

The internal memory 232 may include at least one of a volatile memory (e.g., a dynamic random access memory (RAM) (DRAM), a static RAM (SRAM), a synchronous DRAM (SDRAM), etc.), and a non-volatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, etc.). The internal memory 232 may also be in the form of a solid state drive (SSD).

The external memory 234 may include a flash drive, e.g., a compact flash (CF), a secure digital (SD), a micro-SD, a mini-SD, an extreme digital (xD), a memory stick, etc.

The communication module 220 includes a cellular module 221, a Wi-Fi module 223, a BT module 225, a GPS module 227, and an NFC module 228, and a Radio Frequency (RF) module 229.

The wireless communication module 220 may provide a wireless communication function by using a radio frequency. Additionally or alternatively, the wireless communication module 220 may include a network interface (e.g., a LAN card), a modulator/demodulator (modem), etc., for connecting the hardware to a network (e.g., the Internet, a LAN, a WAN, a telecommunication network, a cellular network, a satellite network, a POTS, etc.).

The RF module 229 may be used for transmission and reception of data, for example, transmission and reception of RF signals or called electronic signals. The RF unit 229 may include a transceiver, a power amplifier module (PAM), a frequency filter, a low noise amplifier (LNA), etc. The RF module 229 may further include a component for transmitting and receiving electromagnetic waves in a free space in a wireless communication, e.g., a conductor, a conductive wire, etc.

The sensor module 240 may measure a physical quantity or may sense an operating state of the electronic device, and may convert the measured or sensed information to an electrical signal.

The sensor module 240 includes a gesture sensor 240A, a gyro sensor 240B, an atmospheric pressure sensor 240C, a magnetic sensor 240D, an acceleration sensor 240E, a grip sensor 240F, a proximity sensor 240G, a red, green and blue (RGB) sensor 240H, a biometric sensor 240I, a temperature/humidity sensor 240J, an illumination sensor 240K, and an ultra violet (UV) sensor 240M.

Additionally/alternatively, the sensor module 240 may include an E-nose sensor, an electromyography (EMG) sensor, an electroencephalogram (EEG) sensor, an electrocardiogram (ECG) sensor, a fingerprint sensor, etc.

The sensor module 240 may further include a control circuit for controlling one or more sensors included therein.

The input device 250 includes a touch panel 252, a pen sensor 254 (e.g., a digital pen sensor), a key 256, and an ultrasonic input unit 258.

The touch panel 252 may recognize a touch input in at least one of a capacitive scheme, a resistive scheme, an infrared scheme, and an acoustic wave scheme. Also, the touch panel 252 may further include a controller. In the capacitive type, the touch panel 252 is capable of recognizing proximity as well as a direct touch.

The touch panel 252 may further include a tactile layer. In this event, the touch panel 252 may provide a tactile response to the user.

The pen sensor 254 (e.g., a digital pen sensor) may be implemented by using a method identical or similar to a method of receiving a touch input from the user, or by using a separate sheet for recognition.

For example, a key pad or a touch key may be used as the key 256.

The ultrasonic input unit 258 senses a sound wave by using a microphone 288 through a pen generating an ultrasonic signal, and to identify data. The ultrasonic input unit 258 is capable of wireless recognition.

The electronic device may also receive a user input from an external device (e.g., a network, a computer, or a server), which is connected to the electronic device, through the communication module 230.

The display module 260 includes a panel 262, a hologram device 264, and a projector 266.

The panel 262 may be a liquid crystal display (LCD) and an active matrix organic light emitting diode (AM-OLED) display, etc. The panel 262 may be flexible, transparent, and/or wearable. The panel 262 may include the touch panel 252 and one module.

The hologram 264 may display a three-dimensional image in the air by using interference of light. The display module 260 may further include a control circuit for controlling the panel 262 or the hologram 264.

The interface 270 includes a high-definition multimedia interface (HDMI) 272, a universal serial bus (USB) 274, an optical interface 276, and a D-subminiature (D-sub) 278. Additionally or alternatively, the interface 270 may include SD/multi-media card (MMC) or infrared data association (IrDA).

The audio module 280 may bidirectionally convert between a voice and an electrical signal. The audio module 280 may convert voice information, which is input to or output from the audio module 280, through a speaker 282, a receiver 284, earphones 286, or the microphone 288.

The camera module 291 may capture an image and a moving image. The camera module 291 may include one or more image sensors (e.g., a front lens or a back lens), an image signal processor (ISP), and a flash LED.

The power management module 295 may manage power of the electronic device. The power management module 295 may include a power management integrated circuit (PMIC), a charger integrated circuit (IC), and/or a battery gauge.

The PMIC may be mounted to an IC or an SoC semiconductor. Charging methods may be classified into a wired charging method and a wireless charging method. The charger IC may charge the battery 296, and may prevent an overvoltage or an overcurrent from a charger to the battery 296.

The charger IC may include a charger IC for at least one of the wired charging method and the wireless charging method. Examples of the wireless charging method may include a magnetic resonance method, a magnetic induction method, an electromagnetic method, etc. Additional circuits (e.g., a coil loop, a resonance circuit, a rectifier, etc.) for wireless charging may be added in order to perform the wireless charging.

The battery gauge may measure a residual quantity of the battery 296, or a voltage, a current, and/or a temperature of the battery 296 during the charging.

The battery 296 may supply power by generating electricity, and may be, for example, a rechargeable battery.

The indicator 297 may indicate particular states of the electronic device or a part (e.g., the processor 210) of the electronic device, for example, a booting state, a message state, a charging state, etc.

The motor 298 may convert an electrical signal into a mechanical vibration. The processor 210 may control the motor 298.

The electronic device may also include a processing unit (e.g., a GPU) for supporting a TV module. The processing unit for supporting a TV module may process media data according to various standards, such as digital multimedia broadcasting (DMB), digital video broadcasting (DVB), mediaflo, etc.

Each of the above-described elements of the electronic device may include one or more components, and the name of the relevant element may change depending on the type of the electronic device. The electronic device may include at least one of the above-described elements. Some of the above-described elements may be omitted from the electronic device, or the electronic device may further include additional elements. Also, some of the elements of the electronic device may be combined into one entity, which may perform functions identical to those of the relevant elements before the combination.

Herein, the term “module” may refer to a unit including one or more combinations of hardware, software, and firmware. The term “module” may be interchangeable with terms, such as “unit,” “logic,” “logical block,” “component,” “circuit,” etc. A “module” may be a minimum unit of a component formed as one body or a part thereof, or a minimum unit for performing one or more functions or a part thereof. A “module” may be implemented mechanically or electronically.

For example, a “module” according to an embodiment of the present disclosure may include at least one of an application-specific integrated circuit (ASIC) chip, a field-programmable gate array (FPGA), and a programmable-logic device for performing certain operations, which have been known or are to be developed in the future.

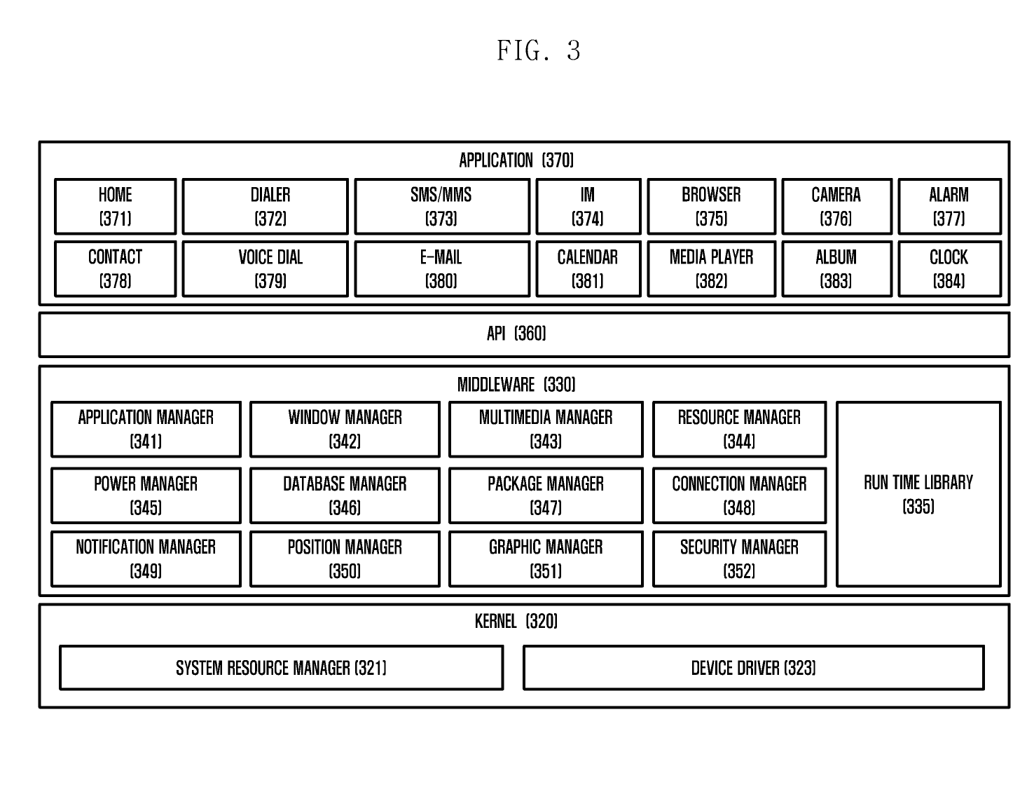

FIG. 3 illustrates a programming module according to an embodiment of the present disclosure.

Referring to FIG. 3, the programming module may be included (or stored) in an electronic device (e.g., in the memory 230 as illustrated in FIG. 2).

At least a part of the programming module may be implemented in software, firmware, hardware, or a combination of two or more thereof. The programming module may be implemented in hardware, and may include an OS controlling resources related to an electronic device and/or various applications (e.g., applications 370) executed in the OS. For example, the OS may be Android®, iOS®, Windows®, Symbian, Tizen®, Samsung Bada OS®, etc.

Referring to FIG. 3, the programming module includes a kernel 320, a middleware 330, an API 360, and the applications 370.

The kernel 320 includes a system resource manager 321 and a device driver 323. The system resource manager 321 may include a process manager, a memory manager, and a file system manager. The system resource manager 321 may perform the control, allocation, recovery, etc., of system resources.

The device driver 323 may include a display driver, a camera driver, a Bluetooth driver, a shared memory driver, a USB driver, a keypad driver, a Wi-Fi driver, and/or an audio driver. The device driver 312 may also include an inter-process communication (IPC) driver.

The middleware 330 may include multiple modules that provide a function used in common by the applications 370. The middleware 330 may also provide a function to the applications 370 through the API 360 in order for the applications 370 to efficiently use limited system resources within the electronic device.

The middleware 330 includes a runtime library 335, an application manager 341, a window manager 342, a multimedia manager 343, a resource manager 344, a power manager 345, a database manager 346, a package manager 347, a connection manager 348, a notification manager 349, a position manager 350, a graphic manager 351, and a security manager 352.

The runtime library 335 may include a library module used by a complier, in order to add a new function by using a programming language during the execution of the applications 370. The runtime library 335 may perform functions that are related to input and output, the management of a memory, an arithmetic function, etc.

The application manager 341 may manage a life cycle of at least one of the applications 370.

The window manager 342 may manage graphic user interface (GUI) resources used on the screen.

The multimedia manager 343 may detect a format used to reproduce various media files and may encode or decode a media file through a codec appropriate for the relevant format.

The resource manager 344 may manage resources, such as a source code, a memory, a storage space, etc., of at least one of the applications 370.

The power manager 345 may operate together with a basic input/output system (BIOS), may manage a battery or power, and may provide power information for an operation.

The database manager 346 may manage a database for the generation, search and/or change of the database to be used by at least one of the applications 370.

The package manager 347 may manage the installation and/or update of an application distributed in the form of a package file.

The connection manager 348 may manage wireless connectivity, e.g., Wi-Fi and Bluetooth.

The notification manager 349 may display or report, to the user, an event such as an arrival message, an appointment, a proximity alarm, etc.

The position manager 350 may manage location information of the electronic device.

The graphic manager 351 may manage a graphic effect, which is to be provided to the user, and/or a user interface related to the graphic effect.

The security manager 352 may provide various security functions used for system security, user authentication, etc.

When the electronic device provides a telephone function, the middleware 330 may further include a telephony manager for managing a voice telephony call function and/or a video telephony call function of the electronic device.

The middleware 330 may generate and use a new middleware module through various functional combinations of the above-described internal element modules. The middleware 330 may provide specialized modules according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 is a set of API programming functions, and may be provided with a different configuration according to an OS. For example, for Android® or iOS®, one API set may be provided to each platform, and for Tizen®, two or more API sets may be provided.

The applications 370 may include a preloaded application and/or a third party application.

The applications 370 include a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, and a clock application 384.

At least a part of the programming module may be implemented by instructions stored in a non-transitory computer-readable storage medium (e.g., the memory 220). When the instructions are executed by one or more processors (e.g., the processors 210), the processors may perform functions corresponding to the instructions.

At least a part of the programming module may be implemented (e.g., executed) by the processor 210. At least a part of the programming module 300 may include a module, a program, a routine, a set of instructions, and/or a process for performing one or more functions.

Names of the elements of the programming module may change depending on the type of OS. The programming module may include one or more of the above-described elements.

Alternatively, some of the above-described elements may be omitted from the programming module, and/or the programming module may further include additional elements.

The operations performed by the programming module or other elements may be processed in a sequential method, a parallel method, a repetitive method, and/or a heuristic method. Also, some of the operations may be omitted, or other operations may be added to the operations.

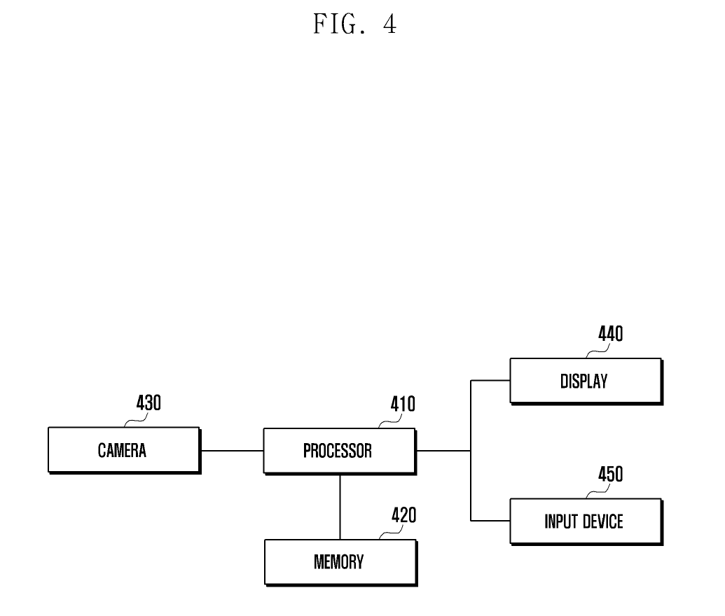

FIG. 4 illustrates an electronic device according to an embodiment of the present disclosure.

Referring to FIG. 4, the electronic device includes a processor 410, a memory 420, a camera 430, a display 440, and an input device 450.

The processor 410 may control general operations of the electronic device. The processor 410 may include an image processing unit for processing an image captured by the camera 430 and an image analyzing unit for analyzing the image.

The image processing unit may be configured with a pre-processor, post-processor, scaler, and codec (coder and decoder). The image processing unit may pre-process and post-process an image output by the camera 430 under the control of the processor 410, and output the image to the display 440 by resizing to the size of the display 440 or to the size of a grid. Further, the image processing unit may compress and encode an image processed under the control of the processor 410 in a photographing mode.

The image analyzing unit may control output by analyzing images stored in the memory 420 and selecting continuously photographed images. The image analyzing unit may analyze each image photographed continuously or input by a user. For example, items of each image analyzed by the image analyzing unit may include a tag, a photographing place, a size of an object, and the clarity of image.

The processor 410 may be configured to analyze a plurality of images captured by the camera 430 and to automatically select an image satisfying a specific condition desired by a user. For example, the processor 410 may select a plurality of images stored in the memory 420 as an object choice, set an option for selecting the plurality of images, select some of the plurality of images, and provide the selected images in a grid form.

The memory 420 may be equipped with a program memory for storing an operating program of the camera 430 and programs according to various embodiments of the present disclosure, and a data memory for storing images (e.g., still images or moving images) captured by the camera 430 or received from another device.

The memory 420 may temporarily store captured images and store images edited by the processor 410 under the control of the processor 410.

The camera 430 may capture a still image and a moving image under the control of the processor 410. The camera 430 may output a plurality of images by continuously capturing an object under the control of the processor 410.

The camera 430 may perform a function of outputting, to the processor 410, by photographing a subject continuously under the control of the processor 410. More specifically, the camera 430 may be configured with a lens for collecting the light, an image sensor for converting the light to an electric signal (e.g., a complementary metal oxide semiconductor (CMOS) or a charge coupled device (CCD)), and an ISP for outputting, to the processor 410, by converting an analog electric signal received from the image sensor to digital image data.

The ISP of the camera 430 may further include a display control module for processing the image data to a preview image (e.g., adjusting a resolution suitably for the screen size of the display 440) and a coding module for outputting to the processor by coding the image data (e.g., compressing in an MPEG format).

The processor 410 may display the preview image through the display 440. Further, the processor 410 may store the coded moving image in the memory 420.

The display 440 may display a recently captured image in a preview form or display an image stored in the memory 420, under the control of the processor 410. The display 440 may display images selected by the processor in a grid form under the control of the processor 410.

The input device 450 may include a touch panel using at least one of an electrostatic method, pressure-sensitive method, infrared method, ultrasonic method, etc.

The input device 450 may detect a touch input for controlling a photographing function of the camera 430. In addition, the input device may detect a touch input for selecting a plurality of images stored in the memory 420 as an object choice, touch input for setting an option to select images, and touch input for setting a grid form.

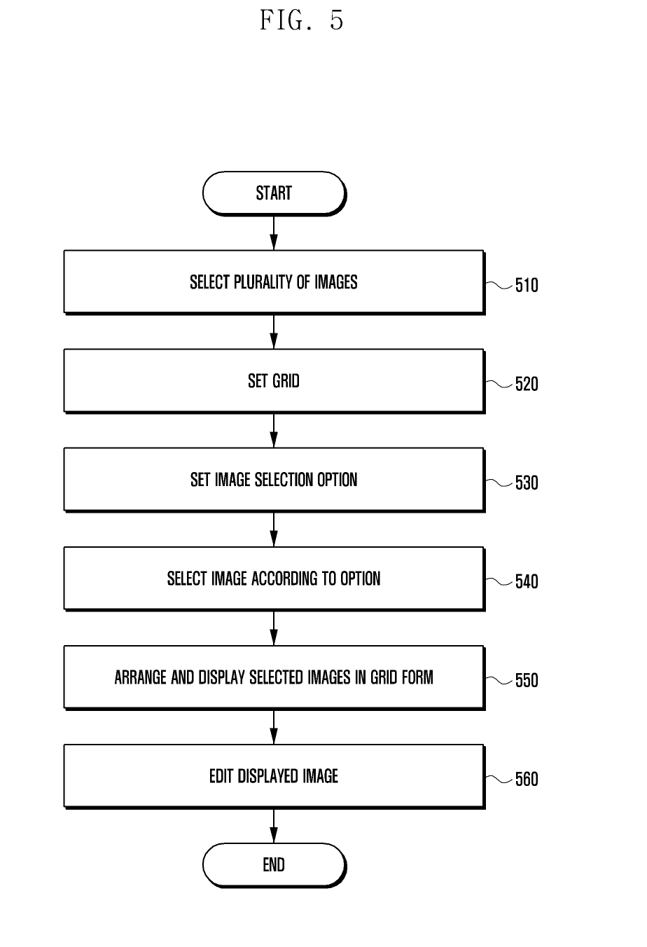

FIG. 5 is a flowchart illustrating a method for processing an image in an electronic device according to an embodiment of the present disclosure. For example, the method of FIG. 5 will be described below as being performed by the electronic device of FIG. 4.

Referring to FIG. 5, the processor 410 selects an object choice from a plurality of images stored in the memory 420 in step 510. For example, the processor 410 may be configured to select images captured continuously or images selected by a user input as object choices.

More specifically, the memory 420 may store images continuously captured in a separate folder or folders generated according to the dates when and/or places at which the images were captured, under the control of the processor 410. For example, the memory 420 may store N images captured on the same day in a specific folder.

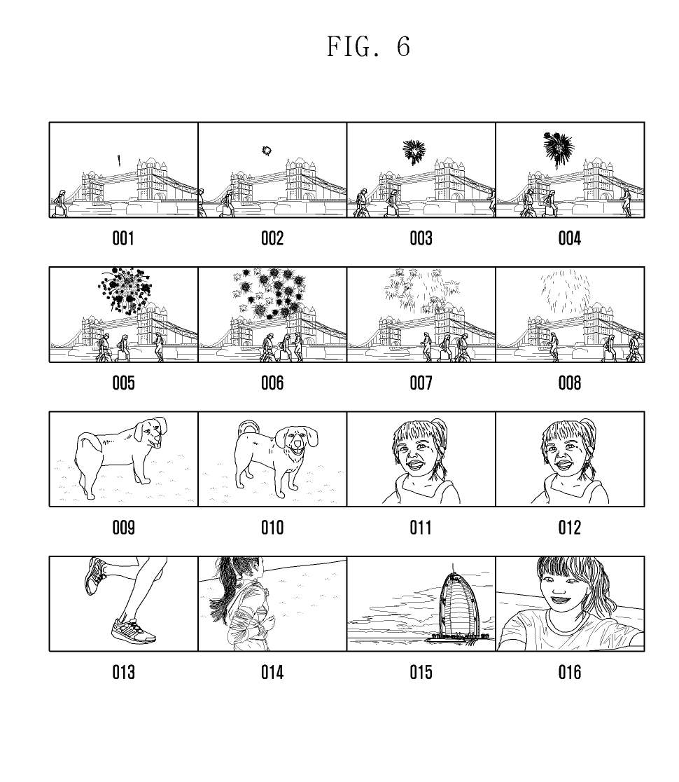

FIG. 6 illustrates a plurality of images stored in a memory according to an embodiment of the present disclosure.

Referring to FIG. 6, images 001 to 008 were continuously captured and images 009 to 016 were captured in a single frame.

The processor 410 can select an image stored in the specific folder automatically or in response to a user's image selection event.

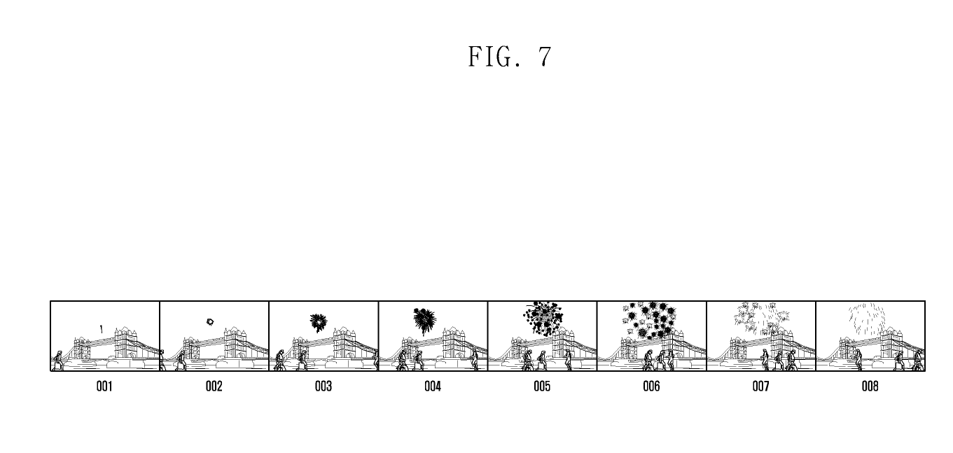

FIG. 7 illustrates a plurality of images selected as object choices according to an embodiment of the present disclosure.

Referring to FIG. 7, if the images are set for automatic selection, the processor 410 may select the images 001 to 008 captured continuously as object choices by analyzing the plurality of images stored in the specific folder. However, if the images are set for manual selection, the processor 410 may select the images as object choices in response to a user input.

The images selected as object choices by the processor 410 may be stored temporarily in a buffer of the memory 420.

Referring again to FIG. 5, the processor 410 sets a grid form in step 520. For example, the processor 410 may provide a screen for setting a grid to display the selected images by controlling the display 440.

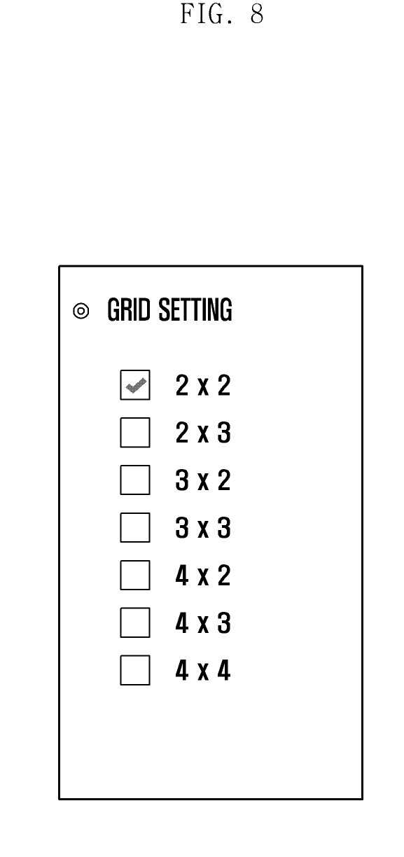

FIG. 8 illustrates a grid setting screen according to an embodiment of the present disclosure.

Referring to FIG. 8, the grid setting screen may be used to select a grid form from 2×2, 2×3, 3×2, 3×3, 4×2, 4×3, and 4×4 formats. Other forms not shown in FIG. 8 may also be available.

Referring again to FIG. 5, the processor 410 sets an option for selecting an image in step 530. For example, the processor 410 may provide a screen for setting an option to select an image by controlling the display 440.

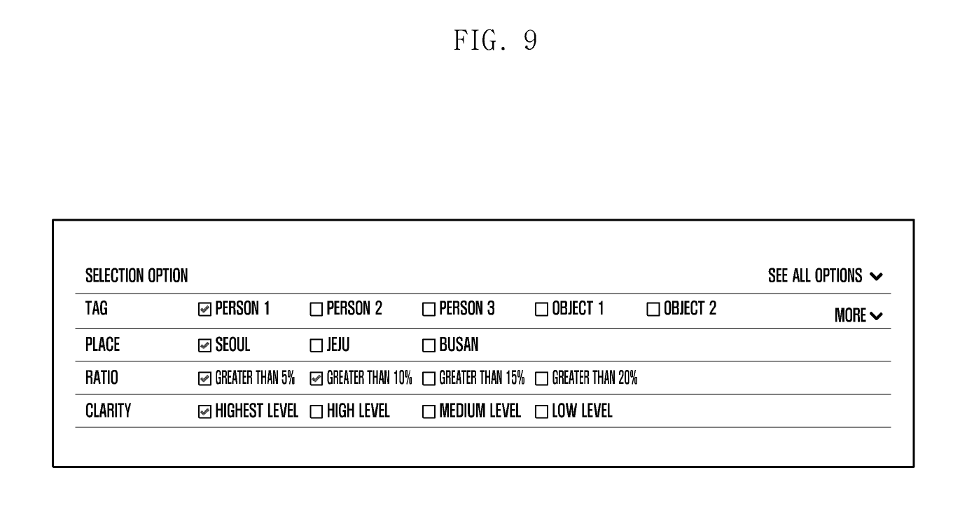

FIG. 9 illustrates an image selection option screen according to an embodiment of the present disclosure.

Referring to FIG. 9, the image selection option screen includes selection items of a tag, a place, a ratio of an object occupying a corresponding image, and clarity.

The image analyzing unit of the processor 410 may analyze a tag, photographing place, object size, and image clarity included in each image. The image analyzing unit then generates option items according to the result of analysis and controls the display 440 to display the generated option items.

The tag may match with each object included in an image corresponding to an object or a person included in the image. For example, FIG. 9 shows tag options of person 1, person 2, person 3, object 1, and object 2. Accordingly, the processor 410 can select an image based on at least one of the selected tag option items.

The photographing place indicates the location where the image was captured. Accordingly, the processor 410 can select an image based on one of the selected options provided as a photographing place.

The ratio of an object indicates a ratio of an object occupying an image corresponding to a tag. For example, the processor 410 can select an image including person 1, and calculate the ratio of person 1 by analyzing the size of person 1 in the selected image. The processor 410 can select or unselect the corresponding image according to the calculated ratio of person 1.

The image analyzing unit of the processor 410 may also analyze clarity of each image and sort a plurality of images according to the degree of clarity. For example, the basis of sorting the plurality of images according to the clarity can be classified into the highest, high, medium, and low levels.

Referring again to FIG. 5, the processor 410 selects an image according to the set option in step 540. The processor 410 can select images satisfying the set option from the plurality of images.

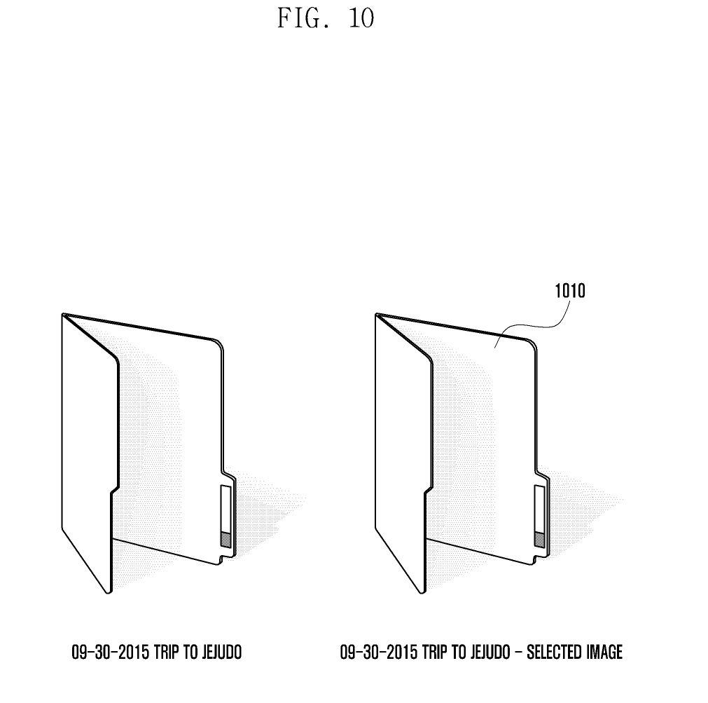

FIG. 10 illustrates images selected and stored in separate folders according to an embodiment of the present disclosure.

Referring to FIG. 10, the processor 410 stores the selected images satisfying the option by generating a separate folder 1010. Accordingly, a user is able to more easily access the selected images.

For example, the processor 410 may select images satisfying all the options from the plurality of images. Alternatively, the processor 410 may select images satisfying at least one option from the plurality of images.

The processor 410 may also arrange the selected images according to the selected options. For example, the arrangement of the images selected by the processor 410 may be a score calculated according to weighted values set for each option. Namely, the processor 410 may provide images in the order of high score to low score by providing a function of selecting images according to the options and calculating a score optimized for the option of selecting the images.

TABLE 1

| | Selected option | Priority |
|---|---|---|
| Tag | Person 1, Object 1 | 1 |
| Place | Seoul | 4 |
| Ratio | Higher than 15% | 3 |
| Clarity | Highest | 2 |

For example, the processor 410 can set a selection basis for a plurality of images as shown in Table 1.

Based on Table 1, the processor 410 may select images including person 1 and object 1, photographed in Seoul, Korea, having size ratios of person 1 and object 1 higher than 15%, and having the highest clarity from the plurality of images.

Referring again to FIG. 5, the processor 410 arranges the plurality of selected images and display the images in the set grid form by controlling the display 440 in step 550.

If the number of images satisfying the above condition is less than 10, it will not take much time even though a user checks the selected images one by one. However, if the number of images satisfying the above conditions is greater than 10, it will take more time for the user to check all the selected images individually. Accordingly, the processor 410 can arrange the selected images in an order to optimize the user's checking. For example, the processor 410 may assign priorities to each option item by applying a weighted value to each option item. The priority may be assigned in the order of a tag, clarity, ratio, and place, as shown in Table 1.

According to the example of Table 1, the processor 410 may arrange images including person 1 and object 1 and having the highest clarity to be viewed first.

The processor 410 may also compare the number of images selected according to each option with a predetermined number, and may omit arranging the selected images, if the number of selected images is less than the predetermined number. Namely, the processor 410 may select images according to each option and compare the number of selected images with the predetermined number. If the number of selected images exceeds the predetermined number, the processor 410 may calculate a score for each selected image, and arrange the images based on the calculated scores.

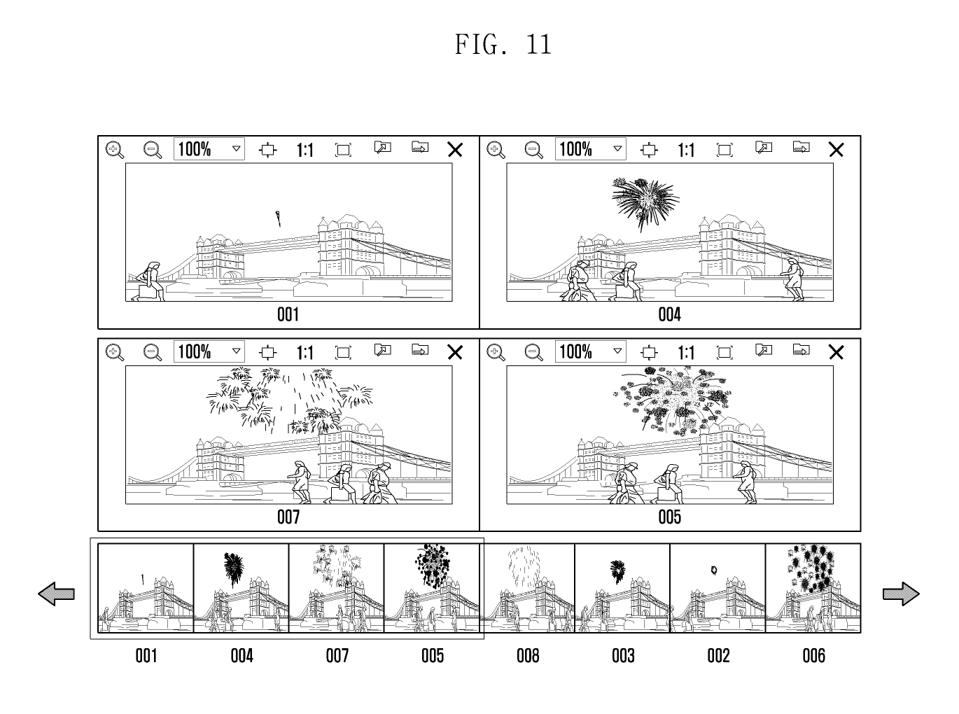

FIG. 11 illustrates a screen for selecting and displaying images in a grid form according to an embodiment of the present disclosure.

Referring to FIG. 11, the image processing unit of the processor 410 may output the selected images to the display 440 by resizing to a grid size. For example, the processor 410 may display the selected images in a grid form by controlling the display 440, and display images having a high score preferentially according to weighted values of the selected options. Among the images 001 to 008 continuously photographed, as object choices, in FIG. 11, the images having higher to lower scores are in the order of image 001, image 004, image 007, image 005, and image 008. Accordingly, the image 001, image 004, image 007, and image 005 are most preferentially displayed in a grid form in FIG. 11.

The processor 410 can display the selected images in a thumbnail form at the bottom of the display windows displayed in a grid form by controlling the display 440.

The processor 410 may also provide a function of simultaneously enlarging or reducing images currently displayed in the grid form. Further, the processor 410 may simultaneously provide photographing information (e.g., EXIF information) for the images displayed in the current grid by controlling the display 440.

Referring again to FIG. 5, the processor 410 provide a function for editing images displayed in a grid form in step 560. For example, the processor 410 may provide a function for simultaneously editing images displayed in the current grid, or all or some of selected images.

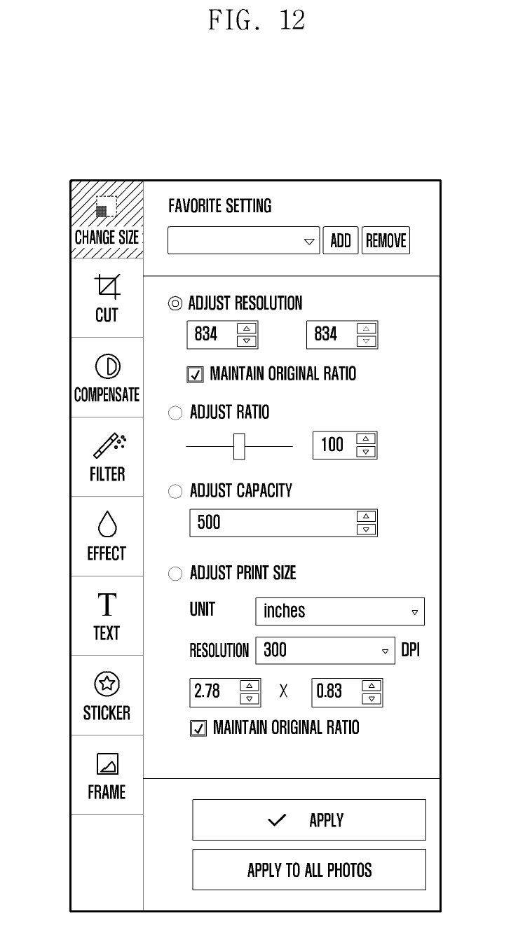

FIG. 12 illustrates a screen for editing a selected image according to an embodiment of the present disclosure.

Referring to FIG. 12, the image processing unit of the processor 410 may provide functions such as changing a size, cutting, compensating, applying a filter, applying an effect, applying a text, applying a sticker, and applying a frame.

As described above, according to various embodiments of the present disclosure, a device and a method are provided for selecting an optimum image desired by a user by analyzing a plurality of images and selecting images satisfying a specific condition desired by the user. Accordingly, the user can search an optimum image, without having to individually check a plurality of images continuously photographed. Further, user convenience is improved because the user can edit selected images simultaneously.

A programming module according to embodiments of the present invention may include one or more of the aforementioned components or may further include other additional components, or some of the aforementioned components may be omitted. Operations executed by a module, a programming module, or other component elements according to various embodiments of the present invention may be executed sequentially, in parallel, repeatedly, or in a heuristic manner. Further, some operations may be executed according to another order or may be omitted, or other operations may be added.

According to various embodiments of the present disclosure, an optimum image may be selected quickly and easily by an electronic device analyzing a plurality of images and automatically selecting an image satisfying a specific condition desired by a user. Accordingly, the user can search an optimum image quickly and easily without having to check individually a plurality of images.

While the present disclosure has been shown and described with reference to certain embodiments thereof, it will be understood by those skilled in the art that various changes in form and detail may be made therein without departing from the spirit and scope of the present disclosure as defined by the appended claims and any equivalents thereof.

What is claimed is:

1. An electronic device comprising:
a memory; and
a processor configured to:
select a plurality of first images stored in the memory,
identify an option for selecting an optimum image from the plurality of selected first images,
select a plurality of second images from the plurality of selected first images based on the identified option, and
display the plurality of selected second images in a grid form.

2. The electronic device of claim 1, wherein the option comprises at least one of:
a tag;
a place at which an image was captured;
a ratio of an object included in the image to a total size of the image; and
clarity of the image, and
wherein the tag is designated to the object.

3. The electronic device of claim 2, wherein the processor is further configured to assign a priority to each of the tag, the place, the ratio, and the clarity of the option by applying a weighted value to each of the tag, the place, the ratio, and the clarity.

4. The electronic device of claim 3, wherein the processor is further configured to calculate a score for each of the plurality of selected second images based on the assigned priorities.

5. The electronic device of claim 4, wherein the processor is further configured to display the plurality of selected second images in an order based on the calculated scores.

6. The electronic device of claim 1, wherein the processor is further configured to store the plurality of selected second images in a separate folder.

7. The electronic device of claim 1, wherein the first images are captured by continuous photographing.

8. The electronic device of claim 1, wherein the first images are selected according to a user input.

9. The electronic device of claim 1, wherein the processor is further configured to set the grid form according to a user input.

10. The electronic device of claim 1, wherein the processor is further configured to simultaneously edit all of the selected second images or at least one of the selected second images displayed in the grid form.

11. A method for processing an image in an electronic device, the method comprising:
selecting a plurality of first images;
identifying an option from a user;
selecting a plurality of second images from the plurality of selected first images based on the identified option; and
displaying the plurality of selected second images in a grid form.

12. The method of claim 11, wherein the option comprises at least one of a tag, a place at which an image was captured, a ratio of an object included in the image to a total size of the image, and clarity of the image, and
wherein the tag is designated to the object.

13. The method of claim 12, further comprising assigning a priority to each of the tag, the place, the ratio, and the clarity of the option by applying a weighted value to each of the tag, the place, the ratio, and the clarity.

14. The method of claim 13, further comprising calculating a score for each of the plurality of selected second images based on the assigned priorities.

15. The method of claim 14, wherein displaying the plurality of selected second images in the grid form comprises displaying the plurality of selected second images in an order based on the calculated scores.

16. The method of claim 11, further comprising storing the plurality of selected second images in a separate folder.

17. The method of claim 11, wherein the first images are captured by continuous photographing.

18. The method of claim 11, wherein selecting the plurality of first images comprises selecting the plurality of first images according to a user input.

19. The method of claim 11, further comprising simultaneously editing all of the selected second images or at least one of the selected second images displayed in the grid form.

20. A recording medium operating in a device, the recording medium configured to store instructions, which when executed by the device, instruct the device to perform a method comprising:
selecting a plurality of first images;
identifying an option from a user;
selecting a plurality of second images from the plurality of selected first images based on the identified option; and
displaying the plurality of selected second images in a grid form.
